(19) United States
(12) Patent Application Publication
(10) Pub. No.: US 2019/0084547 A1
(43) Pub. Date: Mar. 21, 2019

(54) SYSTEMS AND METHODS FOR DETECTING OPERATION OF A BRAKING SYSTEM OF A VEHICLE

(71) Applicant: Robert Bosch GmbH, Stuttgart (DE)

(72) Inventors: Richard Thomas Nesbitt, Stuttgart (DE); Eduardo Herrera Lopez, South Lyon, MI (US)

(21) Appl. No.: 15/708,865

(22) Filed: Sep. 19, 2017

(51) Int. Cl. B60T 17/22; B60T 7/12; G01H 17/00; G10L 25/51; H04R 29/00

(52) U.S. Cl. CPC B60T 17/22; B60T 7/12; H04R 2499/13; G10L 25/51; H04R 29/00; G01H 17/00

(57) ABSTRACT

Systems and methods for detecting operation of a braking system of a vehicle. A system for detecting operation of a braking system of a vehicle comprises a microphone, and an electronic controller, configured to receive an audio signal from the microphone, wherein the audio signal is comprised of a sound caused by contact between at least one tire of the vehicle and a driving surface, generate a noise characteristic from the audio signal, compare the generated noise characteristic to a known noise characteristic, and generate a notification based upon the comparison of the generated noise characteristic to the known noise characteristic.

### FIELD

Embodiments relate to systems and methods for detecting operation of a braking system of a vehicle.

### SUMMARY

The ability to stop a vehicle is important for the safety of the operator of the vehicle, passengers in the vehicle, and other persons. Detecting operation of the braking system in the vehicle is, therefore, also important, especially detecting undesired circumstances or situations, such as wheel lock. Being able to notify an operator of the vehicle that there is a undesired circumstance or situation may allow the operator to take precautionary measures. Further, in a time where autonomous vehicles are becoming more common, having the ability to detect operation of a braking system and being able to take appropriate action in response to undesired circumstances or situations without a driver operating the vehicle is beneficial.

Accordingly, embodiments provided herein disclose, among other things, systems and methods for detecting operation of a braking system in a vehicle.

One embodiment provides a system for detecting operation of a braking system of a vehicle. In one example, the system includes a microphone, and an electronic controller, configured to receive an audio signal from the microphone, wherein the audio signal is comprised of a sound caused by contact between at least one tire of the vehicle and a driving surface, generate a noise characteristic from the audio signal, compare the generated noise characteristic to a known noise characteristic, and generate a notification based upon the comparison of the generated noise characteristic to the known noise characteristic.

Another embodiment provides a method for detecting operation of a braking system of a vehicle. In one example, the method includes receiving, at an electronic controller, an audio signal from a microphone, wherein the audio signal is comprised of a sound caused by contact between at least on tire of the vehicle and a driving surface, generating, with the electronic controller, a noise characteristic from the audio signal, comparing, with the electronic controller, the generated noise characteristic to a known noise characteristic, and generating, with the electronic controller, a notification based upon the comparison of the generated noise characteristic to the known noise characteristic.

Other aspects, features, and embodiments will become apparent by consideration of the detailed description and accompanying drawings.

### BRIEF DESCRIPTION OF THE DRAWINGS

FIG. 1 illustrates a vehicle with a detection system for detecting operation of a braking system of the vehicle according to one embodiment.

FIG. 2 is a block diagram of an electronic controller according to one embodiment.

FIG. 3 is a flowchart for a method for detecting operation of a braking system according to one embodiment.

### DETAILED DESCRIPTION

Before any embodiments are explained in detail, it is to be understood that this disclosure is not intended to be limited in its application to the details of construction and the arrangement of components set forth in the following description or illustrated in the following drawings. Embodiments are capable of other configurations and of being practiced or of being carried out in various ways.

A plurality of hardware and software based devices, as well as a plurality of different structural components may be used to implement various embodiments. In addition, embodiments may include hardware, software, and electronic components or modules that, for purposes of discussion, may be illustrated and described as if the majority of the components were implemented solely in hardware. However, one of ordinary skill in the art, and based on a reading of this detailed description, would recognize that, in at least one embodiment, the electronic based aspects of the invention may be implemented in software (for example, stored on non-transitory computer-readable medium) executable by one or more processors. For example, “control units” and “controllers” described in the specification can include one or more electronic processors, one or more memory modules including non-transitory computer-readable medium, one or more input/output interfaces, one or more application specific integrated circuits (ASICs), and various connections (for example, a system bus) connecting the various components.

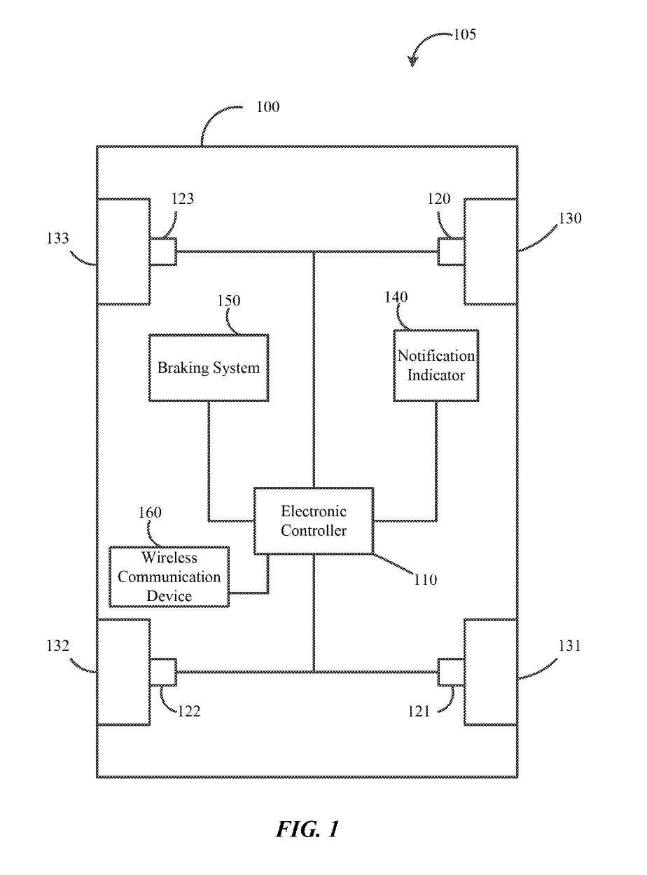

FIG. 1 illustrates a vehicle 100 equipped with a detection system 105 for detecting operation of a braking system of the vehicle 100 according to one embodiment. The vehicle 100, although illustrated as a four-wheeled vehicle in FIG. 1, may encompass various types and designs of vehicles. For example, the vehicle 100 may be an automobile, a motorcycle, a truck, a semi-tractor, and others. In the example illustrated, the detection system 105 comprises an electronic controller 110 and microphones 120, 121, 122, and 123. Each microphone 120, 121, 122, and 123 is positioned adjacent a respective wheel 130, 131, 132, and 133 of the vehicle 100. The vehicle 100 further comprises a notification indicator 140 and a braking system 150.

The electronic controller 110 may be communicatively coupled to the microphones 120, 121, 122, and 123, to the notification indicator 140, and to the braking system 150 via various wired or wireless connections. For example, in some embodiments, the electronic controller 110 is directly coupled via a dedicated wire to each of the above-listed components of the detection system 105. In other embodiments, the electronic controller 110 is communicatively coupled to one or more of the components of the detection system 105 via a shared communication link such as a vehicle communication bus (for example, a controller area network (CAN) bus) or a wireless vehicle network.

The each of the wheels 130, 131, 132, and 133 have, in one embodiment, a rubber tire designed to fit around a rim of each of the wheels 130, 131, 132, and 133. In another embodiment, vehicle 100 does not include wheels 130, 131, 132, and 133 and respective tires. Instead, vehicle propulsion is achieved using continuous tracks. As used herein, unless the context clearly indicates a narrower interpretation “wheel” is intended to encompass traditional wheels, continuous tracks, and other mechanisms used to transfer power to a road surface.

Each of the microphones 120, 121, 122, and 123 is, in one embodiment, configured to detect a sound of one of the respective wheels 130, 131, 132, and 133. In one embodiment, the sound is generated by contact between the tire of each respective wheel 130, 131, 132, and 133 and a road surface, such as asphalt, cement, concrete, and the like. In another embodiment, the sound is a known noise characteristic of the vehicle 100, such as a known noise characteristic for wheel lock (i.e., a circumstance where one or more wheels of the vehicle do not rotate and tires of the vehicle skid across a road), a frozen brake caliper, and the like. In still other embodiments, the sound may be a rotation of the tire of each respective wheel 130, 131, 132, and 133, a sound of a brake caliper or brake pad being applied to the brake of the wheel 130, 131, 132, 133 upon which the tire is mounted, and the like. Each of the microphones 120, 121, 122, and 123 may be a micro-electro-mechanical system (MEMS) microphone. Each of the microphones 120, 121, 122, and 123 may include an electronic processor configured to generate an audio signal from the detected sound. In other embodiments, each of the microphones 120, 121, 122, and 123 only sends the detected sound to the electronic processor 110 and the electronic processor 110 generates the audio signal.

The notification indicator 140 is, in one embodiment, a light-emitting diode (LED) indicator located on a dashboard of the vehicle 100. In another embodiment, the notification indicator 140 is a speaker configured to emit a sound to warn or notify an operator of the vehicle 100. In yet another embodiment, the notification indicator 140 is a display screen. In general, the notification indicator 140 may be any device designed to provide an operator of the vehicle 100 with a notification, alert, or warning using a medium, such as a visual or audio medium. The notification indicator 140 is configured to receive a signal from the electronic processor 110.

The braking system 150 is configured to engage or disengage one or more braking components to one or more wheels of the vehicle 100. The braking components may be components such as brake calipers, brake pads, and the like. The braking system 150, in some embodiments, utilizes hydraulic fluid and hydraulic pressure in order to engage or disengage the one or more braking components. In some embodiments, the braking system 150 also includes a dedicated electronic processor to control the braking system 150. In one embodiment, the braking system 150 is configured to receive a signal at the dedicated electronic processor from the electronic controller 110 and, in response, generate a signal to engage or disengage one or more braking components to the one or more wheels of the vehicle 100. In some embodiments, the braking system 150 is an anti-lock braking system (ABS) configured to maintain longitudinal stability of the vehicle 100 in response to wheel lock.

In some embodiments, the vehicle 100 may be an autonomous vehicle. If the vehicle 100 is an autonomous vehicle, the vehicle 100 may not include the notification indicator 140, as there is no driver of the vehicle 100 present. In some further embodiments, however, the vehicle 100 still has passengers. In these cases, the vehicle 100 still includes the notification indicator 140 to display a warning, alert, or notification to the passengers. Further, one of the passengers may be able to regain manual control of the vehicle 100 in response to a notification or warning being presented to the passenger via the notification indicator 140.

In other embodiments where the vehicle 100 is an autonomous vehicle, the vehicle 100 may further include a wireless communication device 160 (such as an antenna and associated network interface components) that is configured to receive a notification from the electronic controller 110 and broadcast the notification to a remote location. For example, if the vehicle 100 is part of a fleet of autonomous vehicles, and the vehicle 100 experiences wheel lock, the electronic controller 110 may generate a notification to transmit via the wireless communication device 160 to the remote location that the vehicle 100 is experiencing wheel lock, and appropriate measures by an operator at the remote location may be taken.

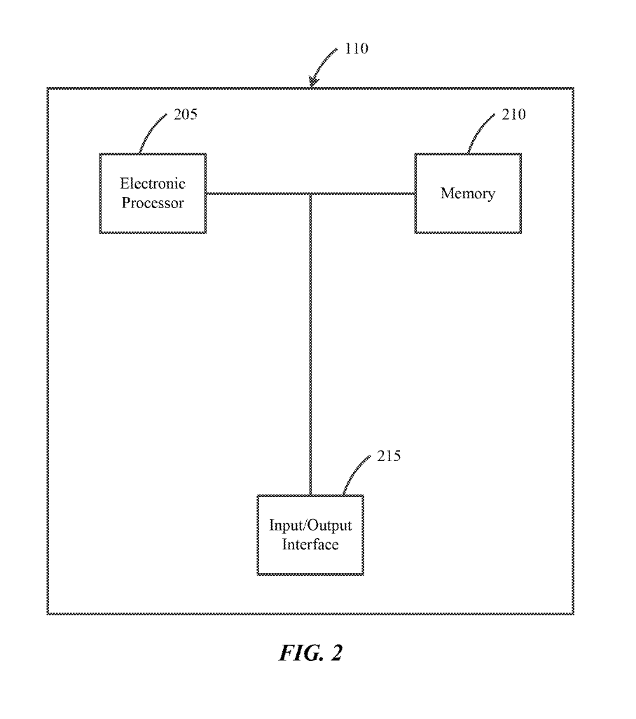

FIG. 2 is a block diagram of the electronic controller 110 according to one embodiment. The electronic controller 110 comprises an electronic processor 205, a memory 210, and an input/output interface 215. The electronic processor 205, the memory 210, and the input/output interface 215 communicate over one or more communication lines or buses, wirelessly, or a combination therefore. In some embodiments, the electronic controller 110 includes additional components than those illustrated in FIG. 2 and the components included in the electronic controller 110 may be arranged in various configurations.

The electronic processor 205 may be a microprocessor, an application-specific integrated circuit (ASIC), or another suitable electronic device. In one example, the electronic processor 205 is configured to retrieve data and instructions from the memory 210 and execute, among other things, software related to the processes and methods described herein. The memory 210 includes a non-transitory, computer-readable storage medium.

The input/output interface 215 may be a wireless transceiver, a modem, and the like. The input/output interface 215 is generally configured to receive input from hardware components external from the electronic controller 110 and provide output from the electronic controller 110 to external hardware components.

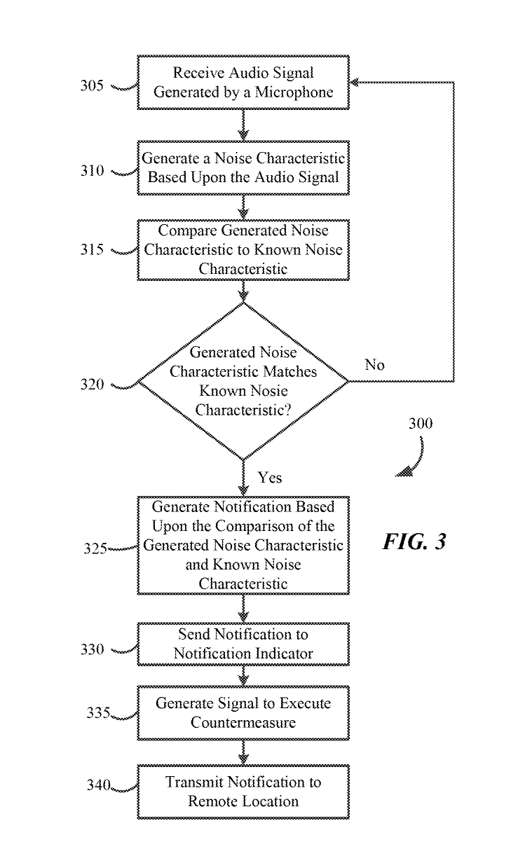

FIG. 3 is a flowchart for a method 300 for detecting operation of a braking system according to one embodiment. The method 300 is performed by the electronic processor 110. The electronic controller 110 is configured to receive an audio signal from a microphone (such as one of the microphones 120, 121, 122, and 123) at block 305. In one example, the audio signal is generated by the one of the microphones 120, 121, 122, and 123 from a sound of one of the tires attached to the wheels 130, 131, 132, and 133. For example, one of the microphones 120, 121, 122, and 123 detects the sound of the one of the tires attached to the wheels 130, 131, 132, and 133 contacting a road. The applicable microphone 120, 121, 122, or 123 gathers audio data of the sound and sends the audio data as an audio signal to the electronic controller 110. In some embodiments, more than one of the microphones 120, 121, 122, and 123 gathers audio data of the sound to send as an audio signal to the electronic controller 110. In other embodiments, more than one sound is detected by the microphones 120, 121, 122, and 123 and an audio signal from each detected sound is sent to the electronic controller 110. In further embodiments, the microphone 120, 121, 122, and 123 are configured to detect a change in the sound generated by the tire attached to the wheel 130, 131, 132, 133 contacting the road. The electronic controller 110 then receives the audio signal at the input/output interface 215.

The electronic controller 110 generates a noise characteristic based upon the received audio signal at block 310. The noise characteristic includes, in one embodiment, a noise level and a noise frequency. For example, the noise characteristic may have a noise level of 50 decibels and have a noise frequency of 1000 Hertz. The noise characteristic may be saved by the electronic controller 110 into the memory 210 in some embodiments. In some embodiments, the electronic controller 110 combines one or more signals from one or more microphones 120, 121, 122, and 123 to generate a composite noise characteristic.

The electronic controller 110 then compares the generated noise characteristic to a known noise characteristic at block 315. The known noise characteristic, in one embodiment, includes a noise level and a noise frequency. For example, the known noise characteristic may be a sound of a locked-up wheel of the vehicle 100, a frozen brake caliper of the vehicle 100, and the like. In one embodiment, the known noise characteristic is saved in the memory 210 of the electronic controller 110. In some embodiments, there is more than one known noise characteristic saved in the memory 210 and the generated noise characteristic is compared by the electronic controller 110 to each known noise characteristic stored in the memory 210. In other embodiments, the electronic controller 110 may process the generated noise characteristic and determine which known noise characteristics stored in the memory 210 to compare the generated noise characteristic to.

The electronic controller 110, when comparing the generated noise characteristic to the known characteristic, in one embodiment, compares the noise levels of the generated noise characteristic and the known noise characteristic and compares the noise frequencies of the generated noise characteristic and the known noise characteristic. In some embodiments, the generated noise characteristic must match the known noise characteristic. In other embodiments, the generated noise characteristic may deviate from the known noise characteristic by a threshold (or a predetermined deviation) and still be considered a match to the known noise characteristic.

If the generated noise characteristic is not a match for a known noise characteristic (at block 320), the electronic controller 110 returns to block 305 of the method 300 and waits to receive another audio signal from the microphone 120, 121, 122, 123. However, if the generated noise characteristic is determined to be a match to a known noise characteristic (at block 320), the electronic controller 110 is configured to generate a notification based upon the comparison of the generated noise characteristic and the known noise characteristic at block 325. For example, if the generated noise characteristic and the known noise characteristic are determined by the electronic controller 110 to match, the electronic controller 110 may create a notification that indicates to an operator of the vehicle 100 that an undesired circumstance or situation related to the known noise characteristic is occurring. For example, if the generated noise characteristic matches the known noise characteristic for a locked-up wheel, the generated notification by the electronic controller 110 indicates to the operator of the vehicle 100 that the vehicle 100 is experiencing a locked-up wheel. In another embodiment, the generated noise characteristic matches a known noise characteristic for two separate wheels of the vehicle 100 being locked-up, and the generated notification indicates that the two wheels of the vehicle 100 are locked up to the operator.

After the notification is generated by the electronic controller 110 at block 325, the electronic controller 110 sends the generated notification to the notification indicator 140 of the vehicle 100 to provide a notification, alert, or warning to the operator of the vehicle 100 (at block 330). For example, in one embodiment the notification indicator 140 is a display screen. The electronic controller 110 determines the vehicle 100 is experiencing wheel lock in a front-right wheel and generates a notification to display on the notification indicator 140. The notification indicator 140 receives the generated notification from the electronic controller 110 and, in the embodiment, displays a schematic of the vehicle 100 on the display screen with the front-right wheel a different color, flashing, or in some other way indicating that the front-right wheel is experiencing wheel lock. Indicating wheel lock on the display screen may further comprise text displayed on the screen stating “The front-right wheel is experiencing wheel lock.”

In some embodiments, the notification indicator 140 is a set of speakers configured to provide an audio notification or warning to an operator of the vehicle 100. For example, the speakers may be the speakers for an audio system of the vehicle 100. In other embodiments, the speakers are separate from the audio system of the vehicle 100. When the electronic controller 110 determines that the vehicle 100 is experiencing wheel lock, the electronic controller 110 may be configured to interrupt any other audio being provided by the speakers (for example, by sending a message to an audio controller) and provide a notification or warning (such as “Wheel lock has been detected”) to the operator of the vehicle 100.

In some embodiments, the electronic controller 110 is further configured to generate a signal to execute a countermeasure in response to determining that a an undesired circumstance or situation has occurred (at block 335). For example, if wheel lock has been detected by the electronic controller 110, the electronic controller 110 may be configured to generate a signal to send to an anti-lock braking system (such as the braking system 150 of the vehicle 100, in some embodiments) in order to control the braking system 150 to reduce hydraulic pressure on the wheel 130, 131, 132, or 133 experiencing wheel lock. Further, the electronic controller may be configured to generate a second notification to send to the notification indicator 140 to notify an operator of the vehicle 100 that, in addition to wheel lock occurring, the braking system 150 is releasing the brake pad from the wheel of the vehicle 100. Due to the notification indicating that this activity will occur, the operator of the vehicle 100 is apprised that the countermeasure will be performed before it actually is. If the vehicle 100 is an autonomous vehicle, the step at block 335 may be necessary if there is no person in the vehicle 100. In some embodiments, however, there is still an operator or operators in the vehicle 100 that may be given manual control of the vehicle 100 as the countermeasure.

In some embodiments, the electronic controller 110 is further configured to generate a signal to transmit the notification via the wireless communication device 160 to a remote location (as shown at block 340). For example, if the electronic processor 110 determines that the vehicle 100 is experiencing wheel lock, in addition to performing other steps in method 300, the electronic processor 110 generates the notification at block 325 and transmits the notification via the wireless communication device 160 to a remote location. This is advantageous if the vehicle 100 is an autonomous vehicle. For example, if the vehicle 100 is part of a fleet of autonomous vehicles, when the notification is received at the remote location, the notification may also include vehicle identification information and location information. Because this information may be included, an operator at the remote location may be able to call repair services in the area of the vehicle 100, warn emergency services in the area of the vehicle 100, or take some other constructive action in order to manage the undesired circumstance or situation detected in the vehicle 100, whether or not the vehicle 100 has passengers or not.

Therefore, embodiments disclosed herein provide, among other things, systems and methods for detecting operation of a braking system in a vehicle.

Various features, advantages, and embodiments are set forth in the following claims.

What is claimed is:

1. A system for detecting operation of a braking system of a vehicle, the system comprising:
a microphone, and
an electronic controller, configured to
receive an audio signal from the microphone, wherein the audio signal is comprised of a sound caused by a wheel of the vehicle,
generate a noise characteristic from the audio signal,
compare the generated noise characteristic to a known noise characteristic, and
generate a notification based upon the comparison of the generated noise characteristic to the known noise characteristic.

2. The system of claim 1, wherein the sound is caused by contact between at least one tire on the wheel of the vehicle and a road surface.

3. The system of claim 1, wherein the generated noise characteristic includes a noise level and a noise frequency.

4. The system of claim 1, wherein the known noise characteristic includes a noise level and a noise frequency.

5. The system of claim 1, the system further comprising a notification indicator.

6. The system of claim 5, wherein the electronic controller is further configured to send the generated notification to the notification indicator.

7. The system of claim 6, wherein the generated notification is an alert to an operator of the vehicle.

8. The system of claim 1, the system further comprising a braking system.

9. The system of claim 8, wherein the braking system comprises one or more braking components and an electronic processor.

10. The system of claim 9, wherein the electronic controller is further configured to generate a signal to send to the electronic processor of the braking system.

11. The system of claim 10, wherein the braking system is configured to execute a countermeasure in response to receiving the signal from the electronic controller.

12. A method for detecting operation of a braking system of a vehicle, the method comprising:
receiving, at an electronic controller, an audio signal from a microphone, wherein the audio signal is comprised of a sound caused by contact between at least on tire of the vehicle and a driving surface,
generating, with the electronic controller, a noise characteristic from the audio signal,
comparing, with the electronic controller, the generated noise characteristic to a known noise characteristic, and
generating, with the electronic controller, a notification based upon the comparison of the generated noise characteristic to the known noise characteristic.

13. The method of claim 12, wherein the generated noise characteristic includes a noise level and a noise frequency.

14. The method of claim 12, wherein the known noise characteristic includes a noise level and a noise frequency.

15. The method of claim 12, the method further comprising sending, via the electronic controller, the generated notification to a notification indicator.

16. The method of claim 15, wherein the generated notification is an alert to an operator of the vehicle.

17. The method of claim 12, the method further comprising generating a signal to send to a braking system of the vehicle.

18. The method of claim 17, wherein the braking system is comprised of one or more braking components and an electronic processor.

19. The method of claim 18, wherein the braking system is configured to execute a countermeasure in response to receiving the signal from the electronic controller.

20. The method of claim 19, wherein the countermeasure includes engaging at least one of the one or more braking components.

21. The method of claim 20, wherein the countermeasure includes disengaging at least one of the one or more braking components.
